(19) United States
(12) Patent Application Publication
(10) Pub. No.: US 2025/0001440 A1
(43) Pub. Date: Jan. 2, 2025

(54) FLUID DISPENSING DEVICE

(71) Applicant: Rust-Oleum Corporation, Vernon Hills, IL (US)

(72) Inventors: Brandon DONNELLY, Round Lake Park, IL (US); Ron OLSON, Vernon Hills, IL (US); Jeffrey HASTIE, Vernon Hills, IL (US); Brian BACIK, Vernon Hills, IL (US); Michael S. SAWANT, Round Lake Park, IL (US); Kyle J. HANSEN, Round Lake Park, IL (US)

(21) Appl. No.: 18/698,663

(22) PCT Filed: Oct. 3, 2022
(86) PCT No.: PCT/US2022/045503

§ 371 Date: Apr. 4, 2024

Related U.S. Application Data
(60) Provisional application No. 63/252,020, filed on Oct. 4, 2021.

(51) Int. Cl. B05B 11/00

(52) U.S. Cl. CPC B05B 11/0078; B05B 11/0056

(57) ABSTRACT

Described herein is a fluid dispensing device that enables rapid fluid mixing of separate solutions prior to dispensing. Also described herein are methods of using and manufacturing the fluid dispensing device. The fluid dispensing device is useful with a variety of reactive and/or concentrated formulations, including cleaning formulations.

### RELATED APPLICATIONS

This application claims priority to U.S. Provisional Application Ser. No. 63/252,020, filed on Oct. 4, 2021, the contents of which are hereby incorporated by reference in their entirety.

### FIELD OF DISCLOSURE

This disclosure is directed to a fluid dispensing device that enables rapid fluid mixing of separate solutions prior to dispensing. The fluid dispensing device is useful with a variety of reactive and/or concentrated formulations, including cleaning formulations.

### BACKGROUND

Fluid dispensing devices are well known in the art. Such devices are used to dispense a wide variety of liquids and chemical formulations. However, previous solutions have not been satisfactory for mixing and dispensing multiple liquids.

The present disclosure provides a fluid dispensing device that overcomes this deficiency and enables rapid fluid mixing of separate solutions prior to dispensing. These fluid mixing capabilities are applicable across a broad range of chemical formulations, including reactive and/or concentrated formulations.

### BRIEF DESCRIPTION OF THE DISCLOSURE

In one aspect, provided herein is a fluid dispensing device comprising: a bottle comprising a first compartment comprising a first fluid and a second compartment comprising a second fluid; a mixing chamber comprising a first inlet portion, a second inlet portion, a mixing component, and a single outlet portion; and a dispensing head comprising an actuator, a pump, a single inlet portion, and an outlet portion. The first inlet portion of the mixing chamber is fluidically coupled to the first compartment of the bottle by a first dip tube, the second inlet portion of the mixing chamber is fluidically coupled to the second compartment of the bottle by a second dip tube, and the single outlet portion of the mixing chamber is fluidically coupled to the single inlet portion of the dispensing head by a tube.

In another aspect, provided herein is a method of using a fluid dispensing device comprising: a bottle comprising a first compartment comprising a first fluid and a second compartment comprising a second fluid; a mixing chamber comprising a first inlet portion, a second inlet portion, a mixing component, and a single outlet portion; and a dispensing head comprising an actuator, a pump, a single inlet portion, and an outlet portion. The first inlet portion of the mixing chamber is fluidically coupled to the first compartment of the bottle by a first dip tube, the second inlet portion of the mixing chamber is fluidically coupled to the second compartment of the bottle by a second dip tube, and the single outlet portion of the mixing chamber is fluidically coupled to the single inlet portion of the dispensing head by a tube. The method comprises actuating the actuator to dispense a dispensing fluid from the fluid dispensing device.

In yet another aspect, provided herein is a method of manufacturing a fluid dispensing device comprising: a bottle comprising a first compartment comprising a first fluid and a second compartment comprising a second fluid; a mixing chamber comprising a first inlet portion, a second inlet portion, a mixing component, and a single outlet portion; and a dispensing head comprising an actuator, a pump, a single inlet portion, and an outlet portion. The first inlet portion of the mixing chamber is fluidically coupled to the first compartment of the bottle by a first dip tube, the second inlet portion of the mixing chamber is fluidically coupled to the second compartment of the bottle by a second dip tube, and the single outlet portion of the mixing chamber is fluidically coupled to the single inlet portion of the dispensing head by a tube. The method comprises assembling the bottle, the mixing chamber, and the dispensing head.

### BRIEF DESCRIPTION OF THE DRAWINGS

FIG. 1 depicts an exemplary embodiment of a fluid dispensing device in accordance with the present disclosure.

FIG. 2 depicts an exemplary embodiment of a simulated mixing chamber in accordance with the present disclosure.

FIG. 3A depicts an exemplary embodiment of a simulation of mixing in a mixing chamber in accordance with the present disclosure.

FIG. 3B depicts another exemplary embodiment of a simulation of mixing in a mixing chamber in accordance with the present disclosure.

FIG. 4 depicts an exemplary embodiment of an array of dip tubes in accordance with the present disclosure.

FIG. 5 depicts an exemplary embodiment of a simulation of flow rates for a fluid dispensing device in accordance with the present disclosure.

FIG. 6 depicts simulation results for calculating volume flow rates required for a desired mixing ratio.

FIG. 7A depicts simulation results for calculating volume flow rates required for a desired mixing ratio for a dip tube length of 233 mm.

FIG. 7B depicts simulation results for calculating volume flow rates required for a desired mixing ratio for a dip tube length of 183 mm.

FIG. 8 depicts an exemplary embodiment of an exploded view of a fluid dispensing device in accordance with the present disclosure.

FIG. 9A depicts a perspective view of a fluid dispensing device in accordance with the present disclosure.

FIG. 9B depicts a side view of a fluid dispensing device in accordance with the present disclosure.

FIG. 10 depicts a cross-sectional view of a dispensing head of a fluid dispensing device in accordance with the present disclosure.

FIG. 11A depicts a perspective view of a first embodiment of a mixing chamber in accordance with the present disclosure.

FIG. 11B depicts a cross-sectional view of a mixing chamber in accordance with the present disclosure.

FIG. 12A depicts a perspective view of a second embodiment of a mixing chamber in accordance with the present disclosure.

FIG. 12B depicts a cross-sectional view of a second embodiment of a mixing chamber in accordance with the present disclosure.

FIG. 13 depicts a perspective view of a cover for a mixing chamber in accordance with the present disclosure.

FIG. 14 depicts a perspective view of another cover for a mixing chamber in accordance with the present disclosure.

FIG. 15 depicts a perspective view of another cover for a mixing chamber in accordance with the present disclosure.

### DETAILED DESCRIPTION OF THE DISCLOSURE

Fluid dispensing devices in accordance with the present disclosure enable rapid fluid mixing of separate solutions prior to dispensing. Among other benefits, such devices allow application of previously unknown and/or unusable chemical formulations.

### Fluid Dispensing Device

The fluid dispensing device comprises a bottle comprising a first compartment comprising a first fluid and a second compartment comprising a second fluid; a mixing chamber comprising a first inlet portion, a second inlet portion, a mixing component, and a single outlet portion; and a dispensing head comprising an actuator, a pump, a single inlet portion, and an outlet portion. The first inlet portion of the mixing chamber is fluidically coupled to the first compartment of the bottle by a first dip tube, the second inlet portion of the mixing chamber is fluidically coupled to the second compartment of the bottle by a second dip tube, and the single outlet portion of the mixing chamber is fluidically coupled to the single inlet portion of the dispensing head by a tube.

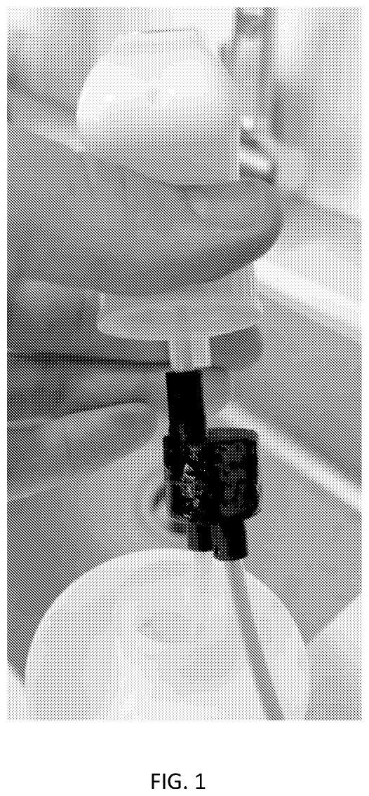

A photograph of a fluid dispensing device is shown in FIG. 1. The yellow inlet solution in the left dip tube mixes with the blue inlet solution in the right dip tube to form a single green solution after passing through a mixing chamber. Thus, the mixing is complete.

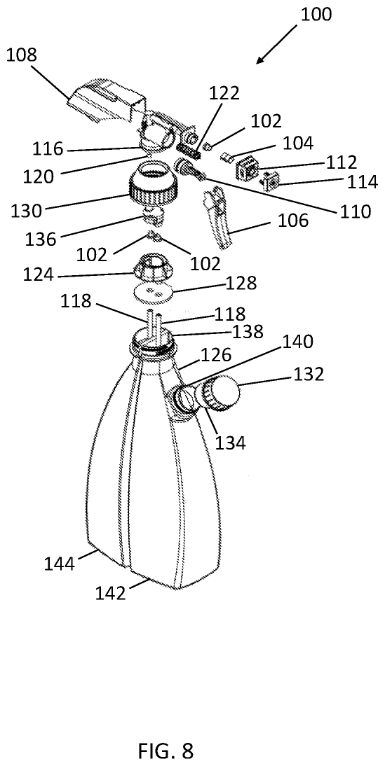

FIG. 8 depicts an exploded view of an embodiment of a fluid dispensing device 100. The labeled components of the exploded view are listed below along with their quantity in the fluid dispensing device 100.

| Label Number | Component | Quantity |
|---|---|---|
| 102 | Valve | 3 |
| 104 | Water Jacket | 1 |
| 106 | Trigger Handle | 1 |
| 108 | Shroud | 1 |
| 110 | Piston | 1 |
| 112 | Nozzle | 1 |
| 114 | Foamer | 1 |
| 116 | Engine | 1 |
| 118 | Dip Tube | 2 |
| 120 | Ball | 1 |
| 122 | Spring | 1 |
| 124 | Mixing Chamber Cover | 1 |
| 126 | Bottle | 1 |
| 128 | Seal Gasket | 1 |
| 130 | Ratcheting Neck/Screw Cap | 1 |
| 132 | Cap | 1 |
| 134 | Cap Seal | 1 |
| 136 | Input Housing of a Mixing | 1 |
| | Chamber | |
| 138 | Dual Chamber Bottle Inlet | 1 |
| 140 | Single Chamber Bottle Inlet | 1 |
| 142 | Front Bottle Chamber | 1 |
| 144 | Back Bottle Chamber | 1 |

The dispensing device 100 includes a dispensing head (not shown) that includes an outlet path including a valve 102, a water jacket 104, a nozzle 112, and a foamer 114. The dispensing head (not shown) includes an engine 116 housed in a shroud 108, where the engine 116 includes a spring 122, a piston 110, a ball 120, and a trigger handle 106. The engine 116 is combined with a mixing chamber 136 in a ratcheting neck 130. The mixing chamber 136 includes two valves 102 and is covered with a mixing chamber cover 124. The mixing chamber 136 is sealed to the bottle 126 with a seal gasket 128 placed over two dip tubes 118 and the ratcheting neck 130 that interfaces with a dual chamber bottle inlet 138. The bottle 126 includes a cap 132 and cap seal 134 to enclose a single chamber bottle inlet 140.

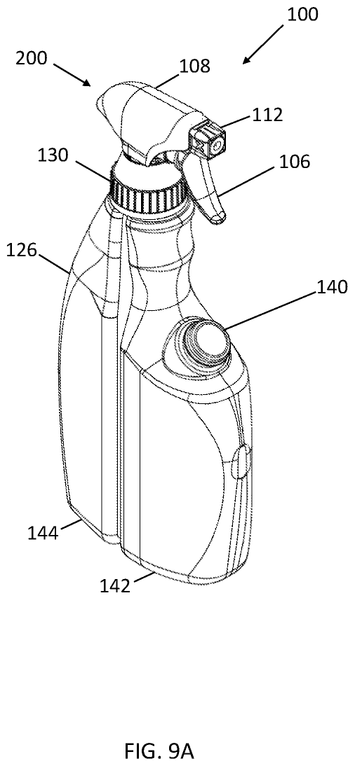

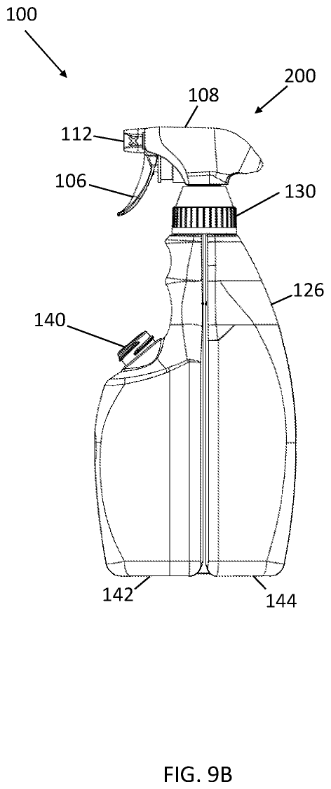

An example embodiment of the fluid dispensing device 100 is shown in FIGS. 9A-9B. In this embodiment, the mixing chamber (not shown) is located within the screw cap 130 between the bottle 126 and the dispensing head 200 including a trigger 106 and shroud 108. The shroud 108 covers the inner mechanism of the dispensing head 200. The bottle 126 includes one opening, the dual chamber bottle inlet (not shown), at the top with a divider between individual openings into a front bottle chamber 142 and a back bottle chamber 144. The bottle also includes a separate opening into the front chamber 142, the single chamber bottle inlet 140, such that it is individually accessible. The front chamber 142 in this embodiment is intended to be filled with water by a user.

### Mixing Chamber

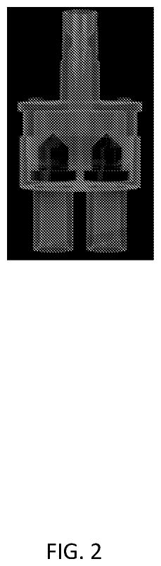

A simulated mixing chamber is shown in FIG. 2. The mixing chamber includes a first inlet portion, a second inlet portion, a mixing component, and a single outlet portion. The first inlet portion of the mixing chamber is fluidically coupled to the first compartment of the bottle by a first dip tube, and control of fluid into the mixing area is provided by a first unidirectional valve (described in further detail below). The second inlet portion of the mixing chamber is fluidically coupled to the second compartment of the bottle by a second dip tube, and control of fluid into the mixing area is provided by a second unidirectional valve. The single outlet portion of the mixing chamber is fluidically coupled to the single inlet portion of the dispensing head by a tube, and flow through the single outlet portion is controlled by a unidirectional outlet valve.

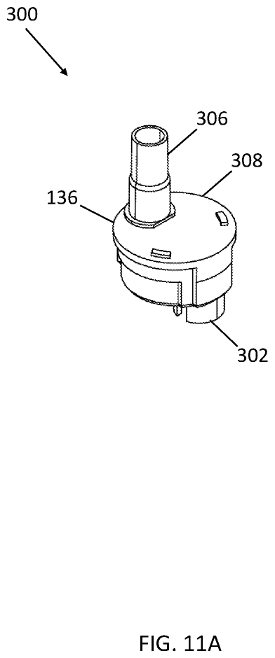

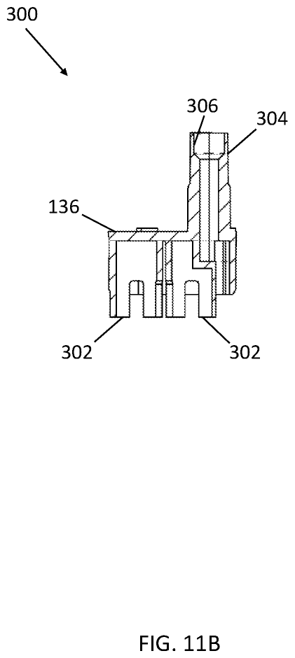

A first embodiment of an input housing 300 that partially defines the mixing chamber 136 is shown in FIGS. 11A-11B. Specifically, an exterior perspective view is shown in FIG. 11A and a cross-sectional view is shown in FIG. 11B. The input housing includes two semi-tubular locating features 302 extending downwardly from an upper wall defining an upper limit of the mixing chamber. Each of the semi-tubular locating features 302 is associated with an inlet valve and dip tube and acts to retain the inlet valve in the proper location within the mixing chamber. The input housing 300 is further shown to include a cylindrical fluid output 304 extending upwardly from the upper wall. In some embodiments, the fluid output 304 includes retention features 306 configured to locate and retain a unidirectional valve (e.g., a ball valve) that controls flow out of the fluid output. The input fluids are mixed in the mixing chamber 136 including a mixing chamber cover 308.

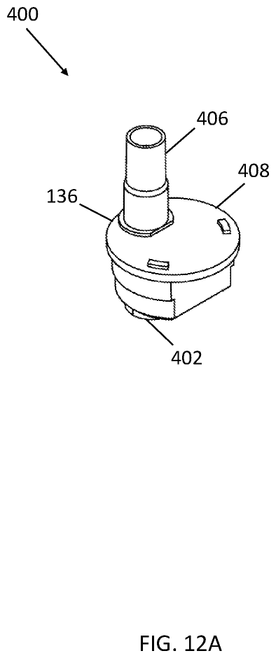

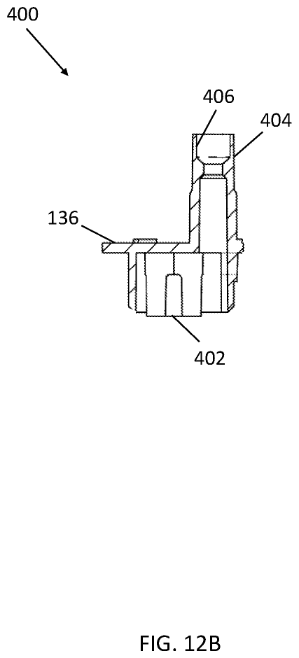

A second embodiment of an input housing 400 is shown in FIGS. 12A-12B. Specifically, an exterior perspective view is shown in FIG. 12A and a cross-sectional view is shown in FIG. 12B. Similar to the input housing 300 depicted in FIGS. 11A-11B, the input housing 400 depicted in FIGS. 12A-12B includes two semi-tubular locating features 402 for the inlet valves and a cylindrical fluid output. The input fluids are mixed in the mixing chamber 136 including a mixing chamber cover 408. In contrast to the input housing 300 depicted in FIGS. 11A-11B, the locating features 402 for the inlet valves of the input housing depicted in FIGS. 12A-12B may be rotated relative to the cylindrical fluid output 406 such that the input housing 400 is able to accommodate bottles (not shown) that are partitioned into compartments in different orientations.

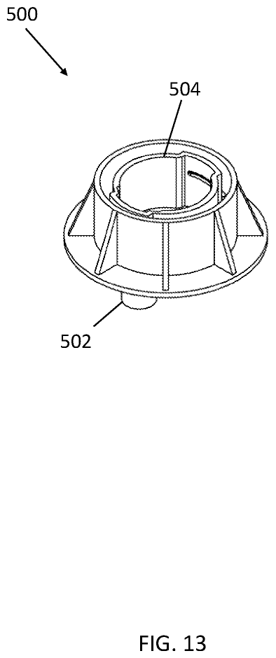

FIG. 13 depicts a perspective view of a cover 500 for a mixing chamber that may be utilized with the input housing 300 of FIGS. 11A and 11B. The cover 500 is configured to define the mixing chamber (not shown) in conjunction with the input housing (not shown). The cover includes cylindrical features 502 extending downwardly from a lower surface of the mixing area 504 that are configured to receive the dip tubes (not shown). Above these dip tube-receiving features 502 and extending upwardly from the lower surface of the mixing area 504, the cover includes two valve-locating features (not shown) (e.g., cylindrical bosses) that ensure the unidirectional valves within the mixing chamber remain optimally positioned relative to the dip tubes. A seal gasket (not shown) may be seated against the lower surface of the mixing area 504. The seal gasket may be fabricated from a compliant material that both prevents paneling (i.e., wall collapse) of the bottle and the flow of any mixed fluid within the mixing chamber back into the unmixed bottle compartments.

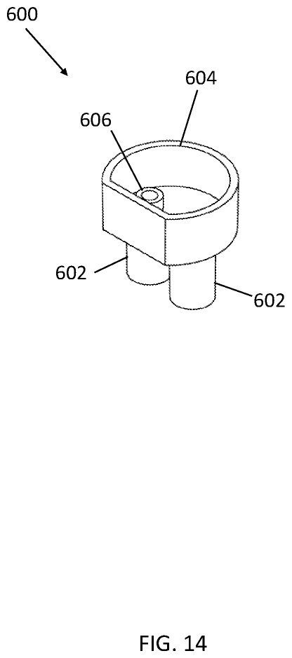

FIG. 14 depicts a perspective view of another cover 600 for a mixing chamber that may be utilized with the input housing 400 of FIGS. 12A and 12B. The cover 600 is configured to define the mixing chamber (not shown) in conjunction with the input housing (not shown). The cover includes cylindrical features 602 extending downwardly from a lower surface of the mixing area 604 that are configured to receive the dip tubes (not shown). Above these dip tube-receiving features 602 and extending upwardly from the lower surface of the mixing area 604, the cover includes two valve-locating features 606 (e.g., cylindrical bosses) that ensure the unidirectional valves within the mixing chamber remain optimally positioned relative to the dip tubes. A seal gasket (not shown) may be seated against the lower surface of the mixing area 604. The seal gasket may be fabricated from a compliant material that both prevents paneling (i.e., wall collapse) of the bottle and the flow of any mixed fluid within the mixing chamber back into the unmixed bottle compartments.

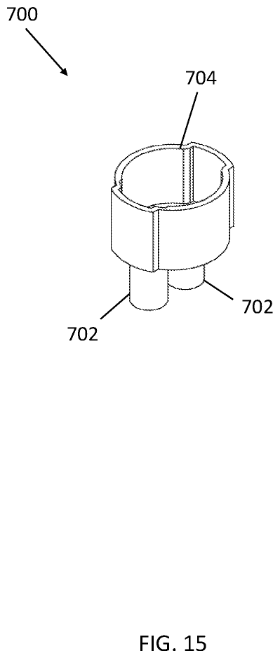

A perspective view of another cover 700 is shown in FIG. 15. The cover 700 is configured to define the mixing chamber (not shown) in conjunction with the input housing (not shown). The cover includes cylindrical features 702 extending downwardly from a lower surface of the mixing area 704 that are configured to receive the dip tubes (not shown). Above these dip tube-receiving features 702 and extending upwardly from the lower surface of the mixing area 704, the cover includes two valve-locating features (not shown) (e.g., cylindrical bosses) that ensure the unidirectional valves within the mixing chamber remain optimally positioned relative to the dip tubes. A seal gasket (not shown) may be seated against the lower surface of the mixing area 704. The seal gasket may be fabricated from a compliant material that both prevents paneling (i.e., wall collapse) of the bottle and the flow of any mixed fluid within the mixing chamber back into the unmixed bottle compartments.

Generally, the purpose and function of the mixing chamber collectively comprising the input housing and the mixing chamber cover is to enable multi-liquid mixing and controlled ratios of components. As described above, this is achieved in part through the use of check valves, which enable the unidirectional flow of liquid and discourage backflow.

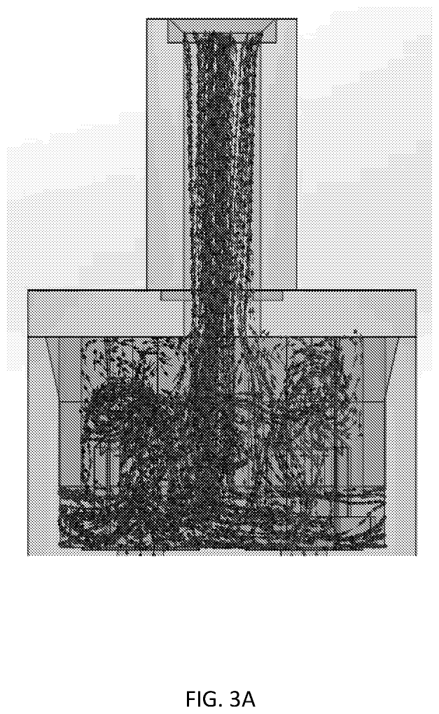

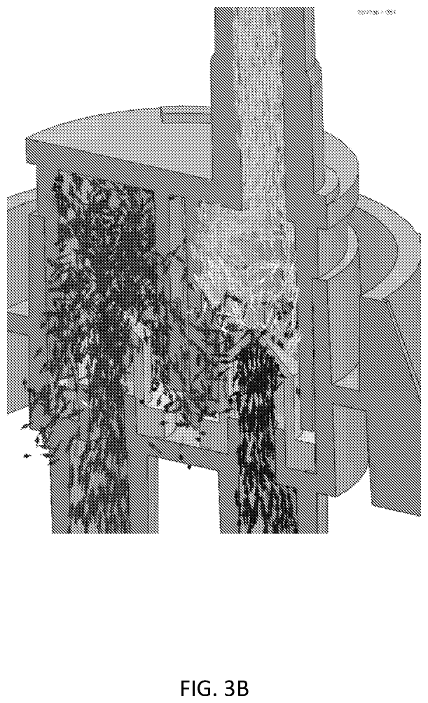

In many embodiments, the mixing chamber enables the dispensing device to combine and dispense two liquids. The two liquids are stored in separate chambers (see FIG. 8) and combined before dispensing. The two liquids, when drawn through their respective dip tubes, are combined and mixed in the mixing chamber before exiting through the single outlet portion (e.g. dip tube) of the dispensing device. The combined fluids exit the dispensing head as in normal sprayer operation. This is visualized in the mixing flow rate simulations shown in FIGS. 3A and 3B. Specifically, FIG. 3A depicts a mixing chamber formed via utilization of the input housing 300 depicted in FIGS. 11A and 11B, in which the semi-tubular locating features, and thus the associated input valves and dip tubes, are spaced equidistant from the cylindrical fluid output. The blue arrows in the left portion of the mixing chamber, representing a first inlet solution, mix with the red arrows in the right portion of the mixing chamber, representing a second inlet solution, to form a single mixture of blue arrows and red arrows after passing through the mixing chamber, representing a mixed dispensing solution.

FIG. 3B depicts a mixing chamber formed via utilization of the input housing 400 depicted in FIGS. 12A and 12B, in which one of the semi-tubular locating features, and thus the associated input valve and dip tube, is positioned closer to the cylindrical fluid output than the other semi-tubular locating feature. The red arrows in the left portion of the mixing chamber, representing a first inlet solution, mix with the blue arrows in the right portion of the mixing chamber, representing a second inlet solution, to form a single mixture of green arrows after passing through the mixing chamber, representing a mixed dispensing solution.

In some embodiments, the fluid dispensing device is configured to mix the first fluid and the second fluid entirely in the mixing chamber to form a dispensing fluid.

In some embodiments, the mixing component is selected from the group consisting of a void volume, a static mixing element, a dynamic mixing element, and combinations thereof. In some embodiments, the mixing component is a void volume. In some embodiments, the mixing component is a void volume such that the first liquid is mixed with air rather than a second liquid.

In some embodiments, the first inlet portion of the mixing chamber comprises a first valve configured to prevent fluidic backflow and the second inlet portion of the mixing chamber comprises a second valve configured to prevent fluidic backflow. In some embodiments, the first valve and the second valve are each individually selected from the group consisting of check valves, ball valves, duckbill valves, and combinations thereof. In some embodiments, the first valve and the second valve each individually comprise a material selected from the group consisting of rubbers, natural rubbers, synthetic rubbers, polymers, and combinations thereof.

In some embodiments, the mixing chamber utilizes duck-billed valves to prevent solutions that have entered the mixing chamber from flowing back into a divided bottle. In these embodiments, this prevents contamination of the formulations contained within the bottle chambers and is necessary due to the potentially reactive chemistries within the bottle.

The mixing chamber may be configured with respect to the dispensing head in a manner known in the art. In some embodiments, the mixing chamber is mechanically coupled to the dispensing head with a fitting selected from the group consisting of snap-fittings, screw fittings, and combinations thereof. In some embodiments, the mixing chamber is not mechanically coupled to the dispensing head. In these embodiments, the mixing chamber is mechanically distinct from the dispensing head.

The mixing chamber may be configured with respect to the bottle in a manner known in the art. In some embodiments, the mixing chamber is mechanically coupled to the bottle. In these embodiments, the mixing chamber is mechanically coupled to the bottle with a fitting selected from the group consisting of snap-fittings, screw fittings, and combinations thereof. In these embodiments, the mixing chamber is located inside the bottle or outside of the bottle.

In some embodiments, the mixing chamber is not mechanically coupled to the bottle. In these embodiments, the mixing chamber is mechanically distinct from the bottle. In these embodiments, the mixing chamber is located outside of the bottle.

### Actuator

Generally, the actuator may be any suitable actuating mechanism or means known in the art. The actuator enables dispensing of the fluid by actuating the pump. In some embodiments, the actuator is a trigger. In some embodiments, the actuator is selected from the group consisting of trigger actuators, mechanical triggers, electrical triggers, trigger engines, pull triggers, push triggers, squeeze triggers, pump actuators, squeeze bottles, and combinations thereof.

### Dip Tubes

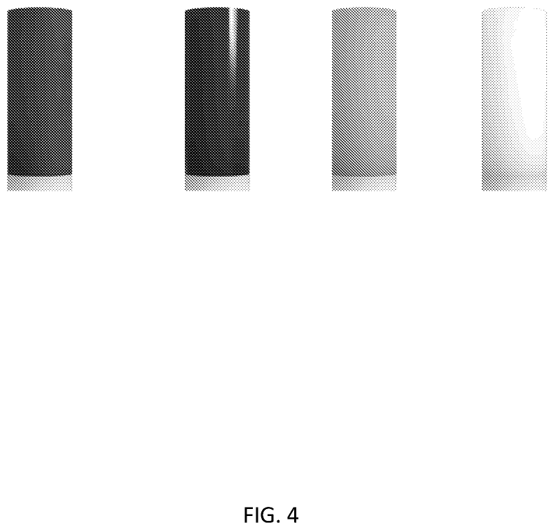

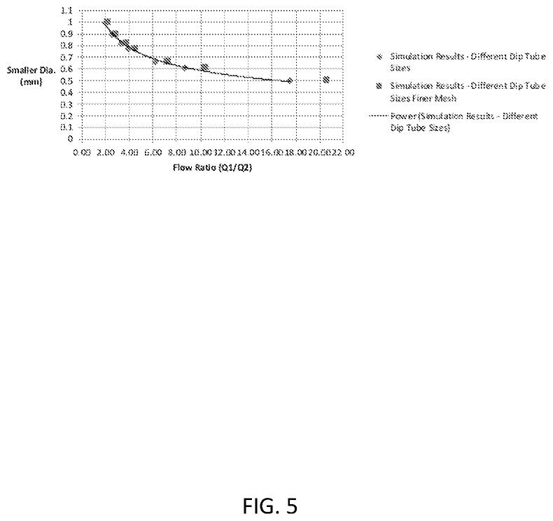

An array of dip tubes is shown in FIG. 4. From left to right, the dip tubes are colored red, blue, yellow, and white. Each of the dip tubes depicted in FIG. 4 has a different internal diameter that is readily ascertained by its coloration. The impact of the sizes of the dip tubes is shown in FIG. 5.

These dip tubes may be used in various combinations with the fluid dispensing device. The dip tubes provide ease of identification and installation of variable inner diameter dip tubes. The upper portion of the dip tubes may be colored and/or dyed, including to have different colors and/or dyes for different internal diameters of the dip tubes. In some embodiments, the first fluid is configured to flow through the first dip tube and the second fluid is configured to flow through the second dip tube.

The coloration of the dip tubes is particularly beneficial during manufacture. The dip tubes may be selected and assembled based on their coloration, which corresponds to their internal diameters. In addition, the combination of a constant outer diameter of the dip tube and a varying inner diameter based on coloration provides adaptability due to the single-size design. This approach reduces cost and time constraints in manufacturing.

The color of the dip tube may be visualized by human vision and/or machine vision at the time of manufacture to ensure that the dip tubes are fully inserted. This color leads to better quality assurance during the production process by providing a means and system of ensuring the dip tube insertion is complete. For example, the upper portion of the dip tube could be colored red, and the red coloring will no longer visible when the dip tube is fully inserted into the dispensing device.

The diameters of the first dip tube and the second dip tube may be any useful diameter known in the art. In some embodiments, the first dip tube and the second dip tube have different internal diameters. This aspect enables the fluid dispensing device to be used for a broad range of chemical formulations, including reactive and/or concentrated formulations. In some embodiments, the first dip tube and the second dip tube have identical or similar outer diameters.

In some embodiments, at least one of the first dip tube and the second dip tube have a diameter of at least 0.5 mm, 0.615 mm, 0.665 mm, 0.775 mm, 0.825 mm, 0.9 mm, 1 mm, 1.5 mm, or 2 mm.

In some embodiments, the first fluid and the second fluid are configured to flow at different flow rates. In some embodiments, when the first dip tube and the second dip tube have different internal diameters, the relative flow rates through the dip tubes are different. The relative difference in flow rates is directly proportional to the ratio of the diameters of the first dip tube and the second dip tube. In other words, when the ratio of the diameters of the first dip tube and the second dip tube is large, the flow rate of a first fluid flowing through the first dip tube is significantly higher than the flow rate of a second fluid flowing through the second dip tube. This large ratio is useful, for example, to dilute concentrated formulations with water during use of the fluid dispensing device.

In contrast, when the ratio of the diameters of the first dip tube and the second dip tube is small, the flow rate of a first fluid flowing through the first dip tube is not significantly higher than the flow rate of a second fluid flowing through the second dip tube. This small ratio is useful, for example, to mix reactive formulation components and provide a strong reactive formulation during use of the fluid dispensing device.

In some embodiments, the first dip tube has a larger diameter than the second dip tube. In some embodiments, a ratio of the diameter of the first dip tube and the diameter of the second dip tube is at least 1:1, 2:1, 3:1, 4:1, 5:1, 6:1, 7:1, 8:1, 9:1, or 10:1.

In some preferred embodiments, a ratio of the diameter of the first dip tube and the diameter of the second dip tube is at least 4:1. A ratio of at least 4:1 is advantageous, for example, with water flowing through the first dip tube and a concentrated cleaning formulation flowing through the second dip tube because then the concentrated cleaning formulation is significantly diluted during use of the fluid dispensing device.

The fluid dispensing device is capable of dispensing a variety of fluids. In some embodiments, a viscosity of the first fluid is different from a viscosity of the second fluid. In some embodiments, the viscosity of the first fluid is identical to the viscosity of the second fluid.

The fluid dispensing device is capable of dispensing a broad range of chemical formulations known in the art. In some embodiments, the fluid dispensing device is configured to dispense a formulation selected from the group consisting of reactive formulations, concentrated formulations, cleaning formulations, cleaning formulations requiring oxidative reactions, formulations for use in organic and/or protein stain removal, formulations for use in mold stain removal, oxidative disinfectant formulations, formulations comprising an organic acid, formulations comprising peracetic acid, diluents, solvents, and combinations thereof. In some embodiments, the fluid dispensing device is configured to dispense a formulation selected from the group consisting of cleaners, household cleaners, bathroom cleaners, kitchen cleaners, glass cleaners, stain cleaners, and combinations thereof.

Generally, the fluid dispensing device is capable of combining chemical components that require separation until immediately prior to application. For example, the chemical components may be reactive with each other. The combination of such reactive chemistries enables the use of new reactive formulations, such as cleaning and disinfection formulations, that could outperform conventional cleaning and disinfection products.

As another example, it may be desirable to dilute a chemical concentrate immediately before dispensing. In these embodiments, the fluid dispensing device may be used in the application of concentrated formulations, such as concentrated cleaning formulations, where a user only needs to add a diluent (e.g. water) to a refillable side of a divided bottle. In some embodiments, the fluid dispensing device utilizes dip tubes with differing diameters to draw water from one compartment of a divided bottle at a higher rate than a cleaning solution in the opposite compartment of the same divided bottle. This operating principle depletes the water compartment more rapidly than the cleaning concentrate side of the bottle. The water portion of the bottle can then be refilled with tap water without the user needing to handle any of the cleaning chemistry. In this way, a shortcoming of most conventional cleaning concentrate technologies is overcome.

### Dispensing Head

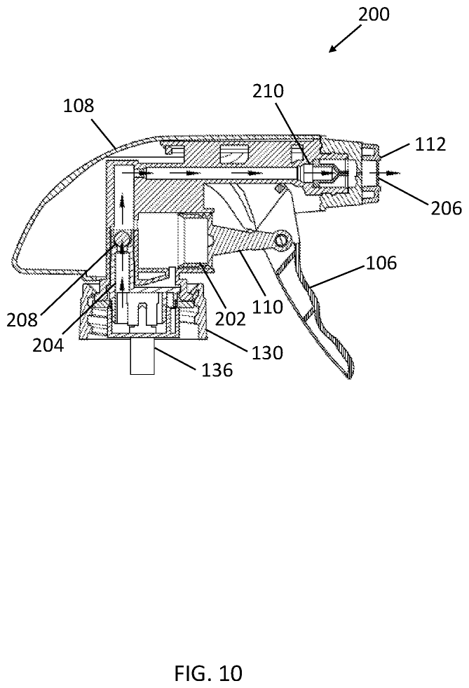

A dispensing head 200 is shown in FIG. 10. In general, the dispensing head 200 comprises an actuator 106, a pump 202, a single inlet portion 204, and an outlet portion 206. A shroud 108 covers some internal portions. The pump 202 includes a piston 110 mechanically coupled with the actuator 106.

The arrows in FIG. 10 depict the flow path and operation of the dispensing head 200. Fluids are mixed in the mixing chamber 136 that is covered by the screw cap 130. The resulting dispensing fluid enters the dispensing head 200 through the single inlet portion 204 upon opening of a check valve 208. The dispensing fluid continues through the dispensing head 200 to the check valve 210 and out the outlet portion 206 through the nozzle 112.

In some embodiments, the dispensing head is configured to receive the dispensing fluid produced by the mixing of the first fluid and the second fluid in the mixing chamber.

In some embodiments, the pump is configured to simultaneously pump the first fluid and the second fluid. In these embodiments, the relative flow rates of the first fluid and the second fluid are controlled by the rate of actuator actuation and the diameters of the dip tubes.

In some embodiments, the dispensing head is configured to utilize check valves to enhance the off-gassing of liquids or mixed liquids that have an active chemistry. In these embodiments, the valves are made of a rubber or synthetic rubber material, deforming after specific pressurization events occur. The system and method can be controlled through the timing and resistance of material before deformation opens the valves to relieve pressure.

In some embodiments, the single inlet portion of the dispensing head comprises a first valve that is configured to prevent fluidic backflow and wherein the outlet portion of the dispensing head comprises a second valve that is configured to prevent fluidic backflow. In some embodiments, the first valve and the second valve are each individually selected from the group consisting of check valves, ball valves, duckbill valves, and combinations thereof. In some embodiments, the first valve and the second valve each individually comprise a material selected from the group consisting of rubbers, natural rubbers, synthetic rubbers, polymers, and combinations thereof.

Preventing backflow in the dispensing head is particularly critical for reactive chemistries because backflow of reactive components could lead to reaction of the components in undesired components of the fluid dispensing device.

### Bottle

The bottle is configured to hold separate multiple solutions. In some embodiments, the bottle is a divided bottle with two separate chambers. In some embodiments, the bottle is a divided bottle with more than two separate chambers. In some embodiments, at least one chamber is individually accessible. In some embodiments, each chamber is individually accessible.

In some embodiments, at least one of the chambers of the bottle comprises water.

The bottle is capable of containing a broad range of chemical formulations known in the art. In some embodiments, the bottle is configured to contain a formulation selected from the group consisting of reactive formulations, concentrated formulations, cleaning formulations, cleaning formulations requiring oxidative reactions, formulations for use in organic and/or protein stain removal, formulations for use in mold stain removal, oxidative disinfectant formulations, formulations comprising an organic acid, formulations comprising peracetic acid, diluents, solvents, and combinations thereof. In some embodiments, the bottle is configured to contain a formulation selected from the group consisting of cleaners, household cleaners, bathroom cleaners, kitchen cleaners, glass cleaners, stain cleaners, and combinations thereof.

### Method of Manufacture.

The fluid dispensing device may be manufactured according to any suitable method known in the art. In many embodiments, the fluid dispensing device is manufactured by assembling the bottle, the mixing chamber, and the dispensing head.

In some embodiments, the method comprises inserting an upper portion of the first dip tube into a portion of the first inlet portion of the mixing chamber and/or inserting an upper portion of the second dip tube into a portion of the second inlet portion of the mixing chamber.

In some embodiments, the first dip tube and the second dip tube are each fully inserted when a color of the dip tube is no longer visible. In some embodiments, the color of the first dip tube and/or the second dip tube is assessed by human vision and/or machine vision.

In some embodiments, the method comprises calculating an appropriate size of the first dip tube and an appropriate size of the second dip tube. In these embodiments, each appropriate size is calculated according to at least one variable selected from the group consisting of the viscosity of the first fluid, the viscosity of the second fluid, the density of the first fluid, the density of the second fluid, the desired flow rate of the first fluid, the desired flow rate of the second fluid, the desired mixing ratio, the desired dilution ratio, and combinations thereof.

### Method of Use

The fluid dispensing device may be used according to any suitable method known in the art. In many embodiments, the actuator is actuated to dispense a dispensing fluid from the fluid dispensing device.

In some embodiments, the method comprises flowing the first fluid through the first dip tube and flowing the second fluid through the second dip tube, wherein the first fluid and the second fluid flow at different flow rates.

In some embodiments, the method comprises mixing the first fluid and the second fluid entirely in the mixing chamber to form the dispensing fluid.

In some embodiments, the method comprises receiving the dispensing fluid in the dispensing head.

### Embodiments of the Present Disclosure Include

Embodiment 1. A fluid dispensing device comprising:
a bottle comprising
   a first compartment comprising a first fluid; and
   a second compartment comprising a second fluid;
a mixing chamber comprising a first inlet portion, a second inlet portion, a mixing component, and a single outlet portion; and
a dispensing head comprising an actuator, a pump, a single inlet portion, and an outlet portion;
wherein:
   the first inlet portion of the mixing chamber is fluidically coupled to the first compartment of the bottle by a first dip tube;
   the second inlet portion of the mixing chamber is fluidically coupled to the second compartment of the bottle by a second dip tube; and
   the single outlet portion of the mixing chamber is fluidically coupled to the single inlet portion of the dispensing head by a tube.

Embodiment 2. The fluid dispensing device of embodiment 1, wherein the fluid dispensing device is configured to mix the first fluid and the second fluid entirely in the mixing chamber to form a dispensing fluid.

Embodiment 3. The fluid dispensing device of embodiment 2, wherein the dispensing head is configured to receive the dispensing fluid.

Embodiment 4. The fluid dispensing device of embodiment 1, wherein the pump is configured to simultaneously pump the first fluid and the second fluid.

Embodiment 5. The fluid dispensing device of embodiment 1, wherein the single inlet portion of the dispensing head comprises a first valve that is configured to prevent fluidic backflow and wherein the outlet portion of the dispensing head comprises a second valve that is configured to prevent fluidic backflow.

Embodiment 6. The fluid dispensing device of embodiment 5, wherein the first valve and the second valve are each individually selected from the group consisting of check valves, ball valves, duckbill valves, and combinations thereof.

Embodiment 7. The fluid dispensing device of embodiment 5, wherein the first valve and the second valve each individually comprise a material selected from the group consisting of rubbers, natural rubbers, synthetic rubbers, polymers, and combinations thereof.

Embodiment 8. The fluid dispensing device of embodiment 1, wherein the mixing component is selected from the group consisting of a void volume, a static mixing element, a dynamic mixing element, and combinations thereof.

Embodiment 9. The fluid dispensing device of embodiment 1, wherein the first inlet portion of the mixing chamber comprises a first valve configured to prevent fluidic backflow and the second inlet portion of the mixing chamber comprises a second valve configured to prevent fluidic backflow.

Embodiment 10. The fluid dispensing device of embodiment 9, wherein the first valve and the second valve are each individually selected from the group consisting of check valves, ball valves, duckbill valves, and combinations thereof.

Embodiment 11. The fluid dispensing device of embodiment 9, wherein the first valve and the second valve each individually comprise a material selected from the group consisting of rubbers, natural rubbers, synthetic rubbers, polymers, and combinations thereof.

Embodiment 12. The fluid dispensing device of embodiment 1, wherein the mixing chamber is mechanically coupled to the dispensing head with a fitting selected from the group consisting of snap-fittings, screw fittings, and combinations thereof.

Embodiment 13. The fluid dispensing device of embodiment 1, wherein the mixing chamber is mechanically coupled to the bottle with a fitting selected from the group consisting of snap-fittings, screw fittings, and combinations thereof.

Embodiment 14. The fluid dispensing device of embodiment 1, wherein the mixing chamber is not mechanically coupled to the bottle.

Embodiment 15. The fluid dispensing device of embodiment 1, wherein the first dip tube and the second dip tube have different internal diameters.

Embodiment 16. The fluid dispensing device of embodiment 1, wherein a viscosity of the first fluid is different from a viscosity of the second fluid.

Embodiment 17. A method of using a fluid dispensing device comprising:
a bottle comprising
   a first compartment comprising a first fluid; and
   a second compartment comprising a second fluid:
a mixing chamber comprising a first inlet portion, a second inlet portion, a mixing component, and a single outlet portion; and
a dispensing head comprising an actuator, a pump, a single inlet portion, and an outlet portion;
wherein:
   the first inlet portion of the mixing chamber is fluidically coupled to the first compartment of the bottle by a first dip tube;
   the second inlet portion of the mixing chamber is fluidically coupled to the second compartment of the bottle by a second dip tube; and
   the single outlet portion of the mixing chamber is fluidically coupled to the single inlet portion of the dispensing head by a tube,
the method comprising actuating the actuator to dispense a dispensing fluid from the fluid dispensing device.

Embodiment 18. The method of embodiment 17, wherein the method comprises flowing the first fluid through the first dip tube and flowing the second fluid through the second dip tube, wherein the first fluid and the second fluid flow at different flow rates.

Embodiment 19. The method of embodiment 17, wherein the method comprises mixing the first fluid and the second fluid entirely in the mixing chamber to form the dispensing fluid.

Embodiment 20. The method of embodiment 17, wherein the method comprises receiving the dispensing fluid in the dispensing head.

Embodiment 21. A method of manufacturing a fluid dispensing device comprising:
a bottle comprising
   a first compartment comprising a first fluid; and
   a second compartment comprising a second fluid:
a mixing chamber comprising a first inlet portion, a second inlet portion, a mixing component, and a single outlet portion; and
a dispensing head comprising an actuator, a pump, a single inlet portion, and an outlet portion;
wherein:
   the first inlet portion of the mixing chamber is fluidically coupled to the first compartment of the bottle by a first dip tube;
   the second inlet portion of the mixing chamber is fluidically coupled to the second compartment of the bottle by a second dip tube; and
   the single outlet portion of the mixing chamber is fluidically coupled to the single inlet portion of the dispensing head by a tube,
the method comprising assembling the bottle, the mixing chamber, and the dispensing head.

Embodiment 22. The method of embodiment 21, wherein the method further comprises inserting a colored upper portion of the first dip tube into a portion of the first inlet portion of the mixing chamber and/or inserting a colored upper portion of the second dip tube into a portion of the second inlet portion of the mixing chamber.

Embodiment 23. The method of embodiment 22, wherein the first dip tube and the second dip tube are each fully inserted when their respective colored upper portions are no longer visible.

Embodiment 24. The method of embodiment 23, wherein the visibility of the color of the first dip tube and/or the second dip tube is assessed by human vision and/or machine vision.

Embodiment 25. The method of embodiment 21, wherein the method further comprises calculating an appropriate size of the first dip tube and an appropriate size of the second dip tube.

Embodiment 26. The method of embodiment 21, wherein each appropriate size is calculated according to at least one variable selected from the group consisting of the viscosity of the first fluid, the viscosity of the second fluid, the density of the first fluid, the density of the second fluid, the desired flow rate of the first fluid, the desired flow rate of the second fluid, the desired mixing ratio, the desired dilution ratio, and combinations thereof.

### EXAMPLES

Without further elaboration, it is believed that one skilled in the art using the preceding description can utilize the present invention to its fullest extent. The following Examples are, therefore, to be construed as merely illustrative, and not limiting of the disclosure in any way whatsoever.

### Example 1. Mixing Simulation

Mixing of two liquids in the mixing chamber was simulated to demonstrate the extent of mixing. Results are shown in FIG. 3. As can be seen, the first liquid (blue arrows) and the second liquid (red arrows) enter from separate chambers but completely mix before exiting from one passage. This is further observed in FIG. 1, where the separate yellow and blue solutions mix to form a single green solution.

### Example 2. Flow Rate Simulation

Flow rates were simulated to demonstrate the effect of the smaller diameter dip tube on the combined flow ratio between first and second liquids. Results are shown in FIG. 5 and Table 1 below. The simulations are based on the viscosity of water, but are applicable to other solutions and liquids.

As seen in Table 1, the diameter of the bigger diameter dip tube was held constant and the diameter of the smaller diameter dip tube was changed. The ratio of flow between a first liquid passing through the bigger diameter dip tube and a second liquid passing through the smaller diameter dip tube was larger when the diameter of the smaller diameter dip tube was relatively small, but larger when the diameter of the smaller diameter dip tube was relatively large. However, the total combined flow rate was constant. In this way, the overall flow rate can be maintained while achieving differing flow ratios.

TABLE 1
Simulation of mix ratios for different dip tube sizes.

| | | | | | | | Flow | Total |
|---|---|---|---|---|---|---|---|---|
| | Bigger | Smaller | Ratio | Area | Area | Flow | rate | Flow |
| | diameter | diameter | of | BD | SD | rate of | of | Rate |
| Length | (mm) | (mm) | flow | (mm²) | (mm²) | BD (cc) | SD (cc) | (cc) |
| 200 | 2 | 0.5 | 17.57 | 3.142 | 0.196 | 1.23 | 0.07 | 1.3 |
| 200 | 2 | 0.615 | 8.70 | 3.142 | 0.297 | 1.166 | 0.134 | 1.3 |
| 200 | 2 | 0.665 | 6.22 | 3.142 | 0.347 | 1.12 | 0.18 | 1.3 |
| 200 | 2 | 0.775 | 3.91 | 3.142 | 0.472 | 1.035 | 0.265 | 1.3 |
| 200 | 2 | 0.825 | 3.33 | 3.142 | 0.535 | 1 | 0.3 | 1.3 |
| 200 | 2 | 0.9 | 2.60 | 3.142 | 0.636 | 0.939 | 0.361 | 1.3 |
| 200 | 2 | 1 | 2.02 | 3.142 | 0.785 | 0.87 | 0.43 | 1.3 |

### Example 3. Modeling of Ratio Mixing

The mixing ratios between first and second liquids were modeled as parallel flow in pipes with pressure losses included. The head losses and volume flow rate can be characterized with the following equations:

$$Q = {Q}_{a} + {Q}_{b}$$

$${h}_{L} = {h}_{La} = {h}_{Lb}$$

Head loss for pipe flow is given by

$${h}_{L} = f \frac{L}{d} \frac{{V}^{2}}{2 g}$$

Where f is Darcy's Friction Factor

$$f = \frac{64}{R e}$$

In the mixing of the present disclosure, the Reynold's number dictates that the flow is in laminar flow. Considering local head losses or pressure losses, the working equation is

$$\frac{{V}_{a}}{{V}_{b}} = {( \frac{\frac{64 {μ}_{b}}{{ρ}_{b} {D}_{b}^{2} {V}_{b}} + \frac{\sum {K}_{b}}{L}}{\frac{64 {μ}_{α}}{{ρ}_{a} {D}_{a}^{2} {V}_{a}} + \frac{\sum {K}_{α}}{L}} )}^{0.5}$$

In the above equations, a refers to the first fluid and b refers to the second fluid. h_{L} represents head loss, V represents volume, μ represents fluid viscosity, ρ represents fluid density, Re represents the Reynold's number, D represents inner diameter of the dip tube. L represents length of the dip tube, ΣK represents the head loss coefficient, and Q represents fluid flow rate.

This working equation is broadly applicable to a wide variety of fluids and dispensing devices.

Velocities in each tube are obtained to yield the volume flow rate required for the ratio of the mix. The working equation was solved through octave programming which includes a Newton Raphson method for root finding and centered finite difference for the slope. The accuracy of the program was verified through comparison of simplified hand calculation results.

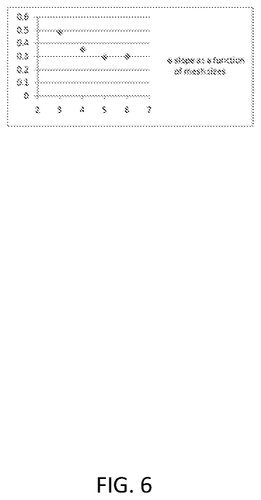

As shown in FIG. 6, simulation through Solidworks was also done for comparison. For accuracy, mesh parameters are increased gradually to find the point where slope of ratio remains constant. Mesh 5 along with the specified local mesh parameters are used to save memory and time.

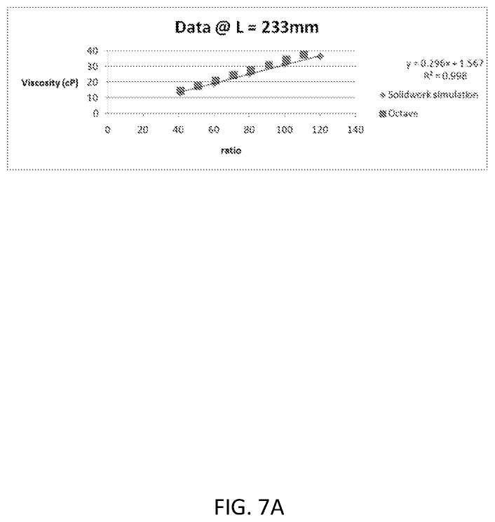

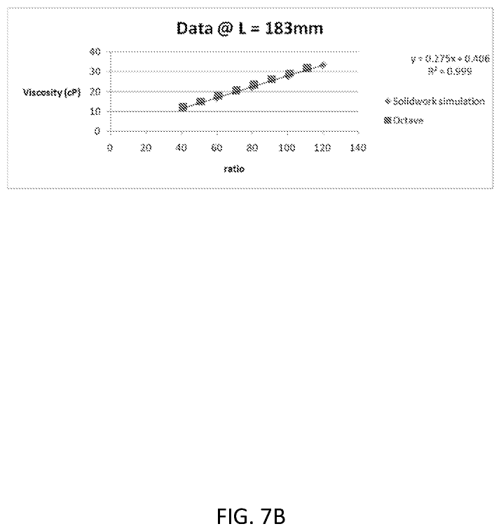

As shown in FIGS. 7A-7B, for testing, viscosity of water was increased through adding of Xanthan Gum. Viscosity ranging from 0.041-0.12 Pa-s was measured through falling sphere method. Results were compared to verify the accuracy of the equations. The equations were then used to predict the dip tube diameters for the required ratios.

This written description uses examples to illustrate the present disclosure, including the best mode, and also to enable any person skilled in the art to practice the disclosure, including making and using any compositions or systems and performing any incorporated methods. The patentable scope of the disclosure is defined by the claims, and may include other examples that occur to those skilled in the art. Such other examples are intended to be within the scope of the claims if they have elements that do not differ from the literal language of the claims, or if they include equivalent elements with insubstantial differences from the literal language of the claims.

As used herein, the terms “comprises.” “comprising,” “includes,” “including,” “has,” “having,” “contains”, “containing,” “characterized by” or any other variation thereof, are intended to cover a non-exclusive inclusion, subject to any limitation explicitly indicated. For example, a composition, mixture, process or method that comprises a list of elements is not necessarily limited to only those elements but may include other elements not expressly listed or inherent to such composition, mixture, process or method.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Where an invention or a portion thereof is defined with an open-ended term such as “comprising,” it should be readily understood that (unless otherwise stated) the description should be interpreted to also describe such an invention using the terms “consisting essentially of” or “consisting of.”

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

As used herein, the term “about” means plus or minus 10% of the value.

What is claimed is:

1. A fluid dispensing device comprising:
a bottle comprising
a first compartment comprising a first fluid; and
a second compartment comprising a second fluid:
a mixing chamber comprising a first inlet portion, a second inlet portion, a mixing component, and a single outlet portion; and
a dispensing head comprising an actuator, a pump, a single inlet portion, and an outlet portion;
wherein:
the first inlet portion of the mixing chamber is fluidically coupled to the first compartment of the bottle by a first dip tube;
the second inlet portion of the mixing chamber is fluidically coupled to the second compartment of the bottle by a second dip tube; and
the single outlet portion of the mixing chamber is fluidically coupled to the single inlet portion of the dispensing head by a tube.

2. The fluid dispensing device of claim 1, wherein the fluid dispensing device is configured to mix the first fluid and the second fluid entirely in the mixing chamber to form a dispensing fluid.

3. The fluid dispensing device of claim 2, wherein the dispensing head is configured to receive the dispensing fluid.

4. The fluid dispensing device of claim 1, wherein the pump is configured to simultaneously pump the first fluid and the second fluid.

5. The fluid dispensing device of claim 1, wherein the single inlet portion of the dispensing head comprises a first valve that is configured to prevent fluidic backflow and wherein the outlet portion of the dispensing head comprises a second valve that is configured to prevent fluidic backflow.

6. The fluid dispensing device of claim 1, wherein the mixing component is selected from the group consisting of a void volume, a static mixing element, a dynamic mixing element, and combinations thereof.

7. The fluid dispensing device of claim 1, wherein the first inlet portion of the mixing chamber comprises a first valve configured to prevent fluidic backflow and the second inlet portion of the mixing chamber comprises a second valve configured to prevent fluidic backflow.

8. The fluid dispensing device of claim 1, wherein the mixing chamber is mechanically coupled to the dispensing head and/or the bottle with a fitting selected from the group consisting of snap-fittings, screw fittings, and combinations thereof.

9. The fluid dispensing device of claim 1, wherein the mixing chamber is not mechanically coupled to the bottle.

10. The fluid dispensing device of claim 1, wherein the first dip tube and the second dip tube have different internal diameters.

11. The fluid dispensing device of claim 1, wherein a viscosity of the first fluid is different from a viscosity of the second fluid.

12. A method of using a fluid dispensing device comprising:
a bottle comprising
a first compartment comprising a first fluid; and
a second compartment comprising a second fluid:
a mixing chamber comprising a first inlet portion, a second inlet portion, a mixing component, and a single outlet portion; and
a dispensing head comprising an actuator, a pump, a single inlet portion, and an outlet portion;
wherein:
the first inlet portion of the mixing chamber is fluidically coupled to the first compartment of the bottle by a first dip tube;
the second inlet portion of the mixing chamber is fluidically coupled to the second compartment of the bottle by a second dip tube; and
the single outlet portion of the mixing chamber is fluidically coupled to the single inlet portion of the dispensing head by a tube,
the method comprising actuating the actuator to dispense a dispensing fluid from the fluid dispensing device.

13. The method of claim 12, wherein the method comprises flowing the first fluid through the first dip tube and flowing the second fluid through the second dip tube, wherein the first fluid and the second fluid flow at different flow rates.

14. The method of claim 12, wherein the method comprises mixing the first fluid and the second fluid entirely in the mixing chamber to form the dispensing fluid.

15. The method of claim 12, wherein the method comprises receiving the dispensing fluid in the dispensing head.

16. A method of manufacturing a fluid dispensing device comprising:
a bottle comprising
a first compartment comprising a first fluid; and
a second compartment comprising a second fluid:
a mixing chamber comprising a first inlet portion, a second inlet portion, a mixing component, and a single outlet portion; and
a dispensing head comprising an actuator, a pump, a single inlet portion, and an outlet portion;
wherein:
the first inlet portion of the mixing chamber is fluidically coupled to the first compartment of the bottle by a first dip tube;
the second inlet portion of the mixing chamber is fluidically coupled to the second compartment of the bottle by a second dip tube; and
the single outlet portion of the mixing chamber is fluidically coupled to the single inlet portion of the dispensing head by a tube,
the method comprising assembling the bottle, the mixing chamber, and the dispensing head.

17. The method of claim 16, wherein the method further comprises inserting a colored upper portion of the first dip tube into a portion of the first inlet portion of the mixing chamber and/or inserting a colored upper portion of the second dip tube into a portion of the second inlet portion of the mixing chamber.

18. The method of claim 17, wherein the first dip tube and the second dip tube are each fully inserted when their respective colored upper portions are no longer visible, and wherein the visibility of the color of the first dip tube and/or the second dip tube is assessed by human vision and/or machine vision.

19. The method of claim 16, wherein the method further comprises calculating an appropriate size of the first dip tube and an appropriate size of the second dip tube.

20. The method of claim 19, wherein each appropriate size is calculated according to at least one variable selected from the group consisting of the viscosity of the first fluid, the viscosity of the second fluid, the density of the first fluid, the density of the second fluid, the desired flow rate of the first fluid, the desired flow rate of the second fluid, the desired mixing ratio, the desired dilution ratio, and combinations thereof.
